(19) United States
(12) Patent Application Publication
(10) Pub. No.: US 2007/0286203 A1
(43) Pub. Date: Dec. 13, 2007

(54) Method and System for Forwarding Traffic in Bearer Network

(75) Inventors: Zhenzhu Lv, Shenzhen (CN); Bo Xu, Shenzhen (CN); Yuepeng Chen, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/773,724

(22) Filed: Jul. 5, 2007

Related U.S. Application Data
(63) Continuation of application No. PCT/CN06/00004, filed on Jan. 5, 2006.

(30) Foreign Application Priority Data
Jan. 5, 2006 (CN) 200510000236.6

(51) Int. Cl. H04L 12/56

(52) U.S. Cl. 370/395.2

(57) ABSTRACT

The embodiments of this invention disclose a method and system for forwarding traffic in a bearer network. The method includes: a CA related to a service call instructing a bearer network resource manager managed by the CA to allocate a QoS policy and reserve resources for the service call; the bearer network resource manager issuing the QoS policy to an edge device in a management domain managed by the bearer network resource manager; the edge device forwarding traffic matching the QoS policy after bearer network resource managers managed by CAs related to the service call successfully allocate QoS policies and reserve resources. With the embodiments of this invention, the bearer network may be controlled precisely whether to forward traffic, and thus it may be avoided effectively that traffic is imported into the bearer network before the service connection is established so as to acquire exact service data amount.

### CROSS-REFERENCE TO RELATED APPLICATIONS

This is a continuation of International Application No. PCT/CN2006/000004, filed Jan. 5, 2006, which claims the benefit of Chinese Patent Application No. CN200510000236.6, filed Jan. 5, 2005, the entire disclosure of which is incorporated herein by reference.

### BACKGROUND OF THE INVENTION

1. Field of the Invention

The invention relates to technologies for a Differentiated Service (Diff-Serv) model with a separate bearer layer, and particularly, to a technology for forwarding traffic in a bearer network.

2. Background of the Technology

Along with the development of the Internet, various techniques for assuring Quality of Service (QoS) are proposed. Therefore, the Internet Engineering Task Force (IETF) put forward many service models and mechanisms to meet demands of QoS. At present, what is recognized in the field is to adopt an Integrated Service (Int-Serv) model at the access to and the border of a network and adopt a Differentiated Service (Diff-Serv) model at the core of the network. The Diff-Serv model guarantees the QoS only by setting priorities. Though with high line utilization efficiency, it is hard to predict specific effects of the Diff-Serv model. In order to improve QoS technologies, a separate bearer control layer and a special Diff-Serv QoS signalling mechanism are set up for the Diff-Serv model of a backbone network. The Diff-Serv model is called a Diff-Serv model having a separate bearer control layer.

FIG. 1 shows a Diff-Serv model with a separate bearer control layer. As shown in FIG. 1, in the Diff-Serv model, bearer control layer 102 is located between bearer network 103 and service control layer 101. The Call Agent (CA) in service control layer 101 is a service server such as a soft switch, a Video on Demand (VOD) control server, and a Gate Keeper (GK). The CA receives a call request from User Equipment (UE) and implements the request and switch of the call as an agent of the UE. Only two CAs are shown in FIG. 1, but a call may relate to one or more CAs. In bearer control layer 102, a bearer network resource manager acquires the topology structure and path resource information of core nodes and Label Switched Paths (LSPs) in the bearer network by learning dynamically or configuring statically. The bearer network resource manager calculates the path resource information and reserves path resources when receiving a resources application from the CA. Although only three bearer network resource managers, e.g., bearer network resource manager 1 (104), bearer network resource manager 2 (105) and bearer network resource manager 3 (106), are shown in FIG. 1, the number of the bearer network resource managers is not limited. The service bandwidth application, the service bandwidth application response, and information of a path allocated by each bearer network resource manager for the service bandwidth application are delivered between bearer network resource managers through signallings. In bearer network 103, each bearer network resource manager manages a specific bearer network domain, which is called a management domain of the bearer network resource manager. In FIG. 1, the management domain includes management domain 107 of bearer network resource manager 1, management domain 108 of bearer network resource manager 2, management domain 109 of bearer network resource manager 3. Management domain 107 includes Edge Router (ER) 110, Core Router (CR) 111 and Border Router (BR) 112. The ER may import call traffic of UE to the bearer network or export the call traffic of UE from the bearer network. Management domains 108 and 109 include CRs and BRs, too.

As shown in FIG. 1, in the process of calling UE 1 calling called UE 2 and establishing a call a connection, CA 1 is a calling CA, CA 2 is a called CA, ER 1 (110) is in management domain 107 of bearer network resource manager 1 and may import this call traffic to the bearer network, and bearer network resource manager 1 is a calling bearer network resource manager managed by CA 1. ER 2 (113) is in management domain 109 of bearer network resource manager 3 and may export this call traffic from the bearer network, and bearer network resource manager 3 is a called bearer network resource manager managed by CA 2. Bearer network resource manager 2 (105) is another bearer network resource manager by which this call traffic passes, which is called a midway bearer network resource manager herein, and management domain 108 is a management domain of bearer network resource manager 2 (105). In some cases, there may be no midway bearer network resource manager, e.g., ER 1 and ER 2 is in the management domain of one bearer network resource manager. Alternatively, there may be multiple midway bearer network resource managers. In FIG. 1, there are multiple management domains, i.e. management domains 107, 108 and 109, in a single separate operating network. However, a service connection may cross multiple separate operating networks and each separate operating network has CAs, bearer network resource managers and a bearer network. The above-mentioned bearer network resource manager may be called a Connection Manager (CM) in the embodiments of the invention.

In the process of establishing the call connection of an end-to-end service including a voice service and a video service, after receiving the call request of calling UE 1, CA 1 negotiates with CA 2 for determining communication capabilities such as the type of the UE, encoding method for the traffic and QoS parameters. After negotiating successfully, CA 1 sends a forward resource request CM 1, CA 2 sends a backward resource request to CM 3. The forward resource request and the backward resource request carry the resources requirements and QoS parameters acquired through the negotiation. After receiving the forward resource request, CM 1 requests, downward hop by hop, a forward QoS policy meeting the resource requirements and QoS parameters and reserves path resources. After receiving the backward resource request, CM 3 requests, upward hop by hop, a backward QoS policy meeting the resource requirements and QoS parameters and reserves path resources. After each CM allocates a QoS policy, the backward QoS policy is sent to CM 3 and the forward QoS policy is sent to CM 1. CM 1 issues the forward QoS policy to ER 1 in the bearer network and CM 3 issues the backward QoS policy to ER 2 in the bearer network. Both the forward QoS policy and the backward QoS policy carry path information from the calling to the called and 5-tuple information. After respectively receiving the forward QoS policy and the backward QoS policy, ER 1 and ER 2 start to forward traffic matching their respective QoS policy. The match between a QoS policy and traffic means the 5- tuple information in the QoS policy matches the 5-tuple information in the traffic. The call connection is established successfully after the forward QoS policy and the backward QoS policy are issued, and then CA 1 sends a response to UE 1 to notify UE 1 to start to send traffic.

However, in the related art, the bearer network resource manager cannot precisely control the ER in the bearer network whether to forward traffic, which may result in the following issues.

When multiple CAs are concerned, both the calling CA and other CAs related to the current call need to instruct the CMs managed by themselves to allocate QoS policies and reserve resources for the current call and issue the QoS policies. The call connection is established successfully until all CAs related to the current call allocate the QoS policies and reserve the resources, and then CA 1 may notify the calling UE to send traffic. The call connection cannot be established successfully if a certain CA fails to allocate a QoS policy and reserve resources. However, the ER receiving the QoS policy may be able to forward traffic matching the received QoS policy. In this way, if the ER receiving the QoS policy forwards traffic once receiving the traffic matching the QoS policy, the traffic will be imported to the bearer network before the call connection is established successfully. As a result, exact traffic amount cannot be acquired, and thus charging based on traffic amount is difficult. That is, it is difficult to charge for the traffic before the call connection is established successfully so as to cause loss to the operator. In addition, if certain UE usurps the 5-tuple information of the calling UE to send traffic to the ER, the ER may also forward the traffic. Thus, loss is brought to the actual calling user.

### SUMMARY OF THE INVENTION

Embodiments of the invention provided a method and a system for forwarding traffic in a bearer network so as to precisely control the bearer network whether to forward the traffic.

A method for forwarding traffic in a bearer network includes:
instructing, by a Call Agent (CA) related to a service call, a bearer network resource manager managed by the CA to allocate a Quality of Service (QoS) policy and reserve resources for the service call;
issuing, by the bearer network resource manager, the QoS policy to an edge device in a management domain managed by the bearer network resource manager; forwarding, by the edge device, traffic matching the QoS policy after bearer network resource managers managed by CAs related to the service call successfully allocate QoS policies and reserve resources for the service call.

The issuing the QoS policy to the edge device in the management domain managed by the bearer network resource manager includes:

issuing the QoS policy to the edge device in the management domain managed by the bearer network resource manager after the CA determines that a bearer network resource manager managed by any other CA related to the service call successfully allocates a QoS policy and reserves resources for the service call.

The issuing the QoS policy includes:

issuing, by the bearer network resource manager, the QoS policy and an instructing forbidding forwarding the traffic matching the QoS policy to the edge device;

the forwarding traffic matching the QoS policy includes:

issuing an instruction allowing forwarding the traffic matching the QoS policy to the edge device after the CA determines that a bearer network resource manager managed by any other CA related to the service call successfully allocates a QoS policy and reserve resources for the service call;

forwarding, by the edge device, the traffic matching the QoS policy after receiving the instruction allowing forwarding the traffic matching the QoS policy.

A system for forwarding traffic in a bearer network includes:

a Call Agent (CA) related to a service call, a bearer network resource manager managed by the CA and an edge device in a management domain managed by the bearer network resource manager; wherein

the CA is configured to instruct the bearer network resource manager to allocate a Quality of Service (QoS) policy and reserve resources for the service call;

the bearer network resource manager is configured to issue the QoS policy after allocating the QoS policy and reserving the resource for the service call;
the edge device is configured to forward traffic matching the QoS policy after bearer network resource managers managed by CAs related to the service call successfully allocate QoS policies and reserve resources for the service call.

The bearer network resource manager managed by the CA issues the QoS policy to the edge device after the CA determines that a bearer network resource manager managed by any other CA related to the service call successfully allocates a QoS policy and reserves resources for the service call.

The bearer network resource manager issues an instruction forbidding forwarding the traffic matching the QoS policy to the edge device when issuing the QoS policy, and issuing an instruction allowing forwarding the traffic matching the QoS policy to the edge device after the CA determines that a bearer network resource manager managed by any other CA related to the service call successfully allocates a QoS policy and reserve resources for the service call;

the edge device forwards the traffic matching the QoS policy after receiving the instruction allowing forwarding the traffic matching the QoS policy.

In the method and system of the embodiments of the invention, the QoS policy is issued to the edge device in the bearer network after the CAs related to the call successfully allocate QoS policies and reserve resources, and the edge device starts to forward traffic matching the QoS policy after receiving the QoS policy. Alternatively, each CA related to the call issues the QoS policy once successfully allocating the QoS policy and reserving the resources, but the edge device does not forward traffic matching the QoS after receiving the QoS policy, and till CAs related to the call successfully allocate QoS policies, reserve resources and issue the QoS policies, the edge device is controlled to forward traffic matching the received QoS policy. Thus, the issue of the QoS policy may be precisely controlled, and the bearer network is also controlled precisely whether to forward traffic. Therefore, it is avoided effectively that traffic enters the bearer network before the service connection is established successfully, and the exact traffic amount may be acquired and the service connection may be managed effectively. For example, charging based on traffic amount may be implemented exactly. In addition, since the bearer network does not forward traffic matching the QoS policy before the service connection is established successfully, illegal traffic are prevented from the bearer network before the service connection is established, and thus the communication security of UE are improved.

### BRIEF DESCRIPTION OF THE DRAWINGS

FIG. 1 shows a conventional Diff-Serv model with a separate bearer control layer.

FIG. 2 shows a flow chart illustrating a method for forwarding traffic in a bearer network in accordance with an embodiment of the invention.

FIG. 3 shows a flow chart illustrating a method for forwarding traffic in a bearer network in accordance with another embodiment of the invention.

FIG. 4 shows a flow chart illustrating a process of establishing a service connection and forwarding bi-directional traffic in a bearer network in which the service layer adopts the Session Initiation Protocol (SIP) in accordance with an embodiment of the invention.

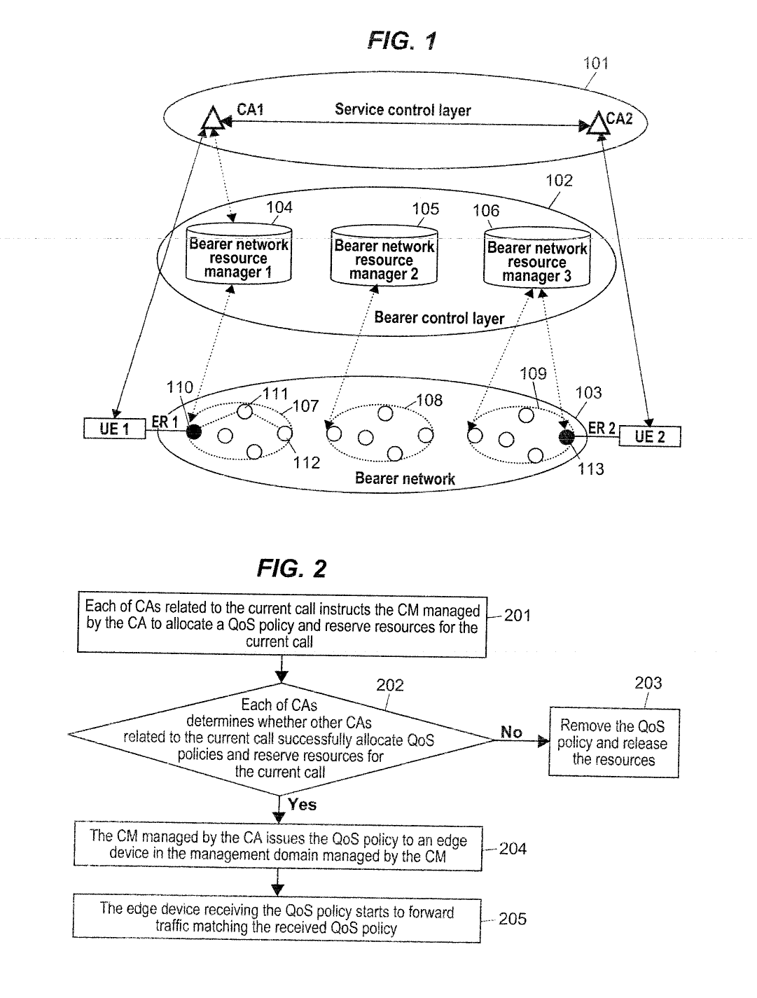

### DETAILED DESCRIPTION OF THE PREFERRED EMBODIMENTS

The invention is hereinafter described in detailed with reference to the accompany drawings and specific embodiments.

If UE and a CA adopt different protocols, support and deal with the protocols in different ways, processing procedures of the UE and the CA are different. In the Diff-Serv model with a separate bearer control layer, the SIP is usually adopted. In the following embodiment, a method for forwarding traffic is described, in which the SIP is adopted.

The following embodiment is described by an example in which bi-directional service connection is established.

The edge device in the embodiments of the invention may be an ER or a network element device with the function of a Label Edge Router (LER).

FIG. 2 shows a flow chart illustrating a method for forwarding traffic in a bearer network in accordance with an embodiment of the invention. As shown in FIG. 2, the processing procedure is included in the process of establishing a service call connection and includes the steps as follows.

Step 201: Each of CAs related to the current call instructs the CM managed by the CA to allocate a QoS policy and reserve resources for the current call, and sends a resource reserving success message to other CAs related to the current call after successfully allocating the QoS policy and reserving the resources.

Step 202˜204: Each of the CAs determines whether the CMs managed by other CAs related to the current call successfully allocate QoS policies and reserve resources for the current call, that is, determines whether each of the CAs receives the resource reserving success messages sent by other CAs; if yes, the CM managed by the CA issues the QoS policy to an edge device in the management domain managed by the CM; otherwise, the CM removes the QoS policy and releases the resources.

Step 205: The edge device receiving the QoS policy starts to forward traffic matching the received QoS policy.

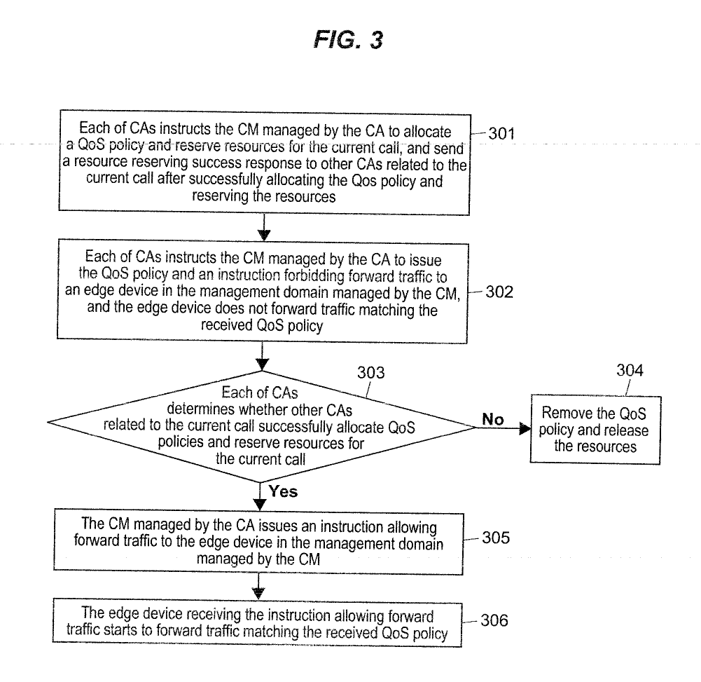

FIG. 3 shows a flow chart illustrating a method for forwarding traffic in a bearer network in accordance with another embodiment of the invention. As shown in FIG. 3, the processing procedure is included in the process of established a service call connection and includes the steps as follows:

Step 301: Each of the CAs related to the current call instructs the CM managed by the CA to allocate a QoS policy and reserve resources for the current call, and sends a resource reserving success message to other CAs related to the current call after the CM managed by the CA successfully allocates the QoS policy and reserves the resources.

Step 302: Each of the CAs instructs the CM managed by the CA to issue the QoS policy and an instruction forbidding forward traffic to an edge device in the management domain managed by the CM, and the edge device receiving the QoS policy and the instruction forbidding forward traffic does not forward traffic matching the received QoS policy.

Steps 303˜305: Each of the CAs determines whether to receive the resource reserving success messages sent by other CAs related to the current call; if yes, the CA instructs the CM managed by the CA to issue an instruction allowing forward traffic to the edge device in the management domain managed by the CM; otherwise, the CA removes the QoS policy and releases the resources.

Step 306; The edge device determines whether to receive the instruction allowing forward traffic; if yes, starts to forward traffic matching the received QoS policy.

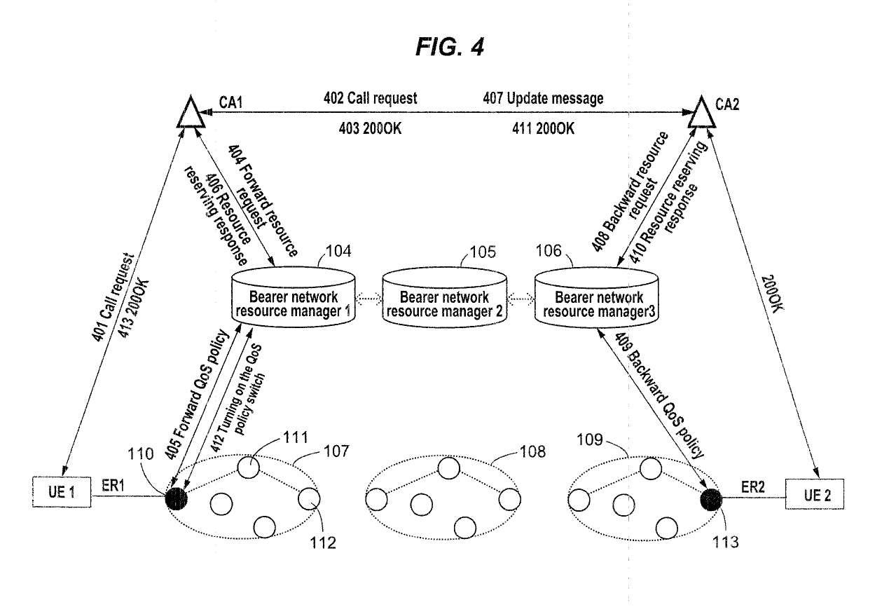

FIG. 4 shows a flow chart illustrating a process of establishing a service connection and forwarding bi-directional traffic in a bearer network in which the service layer adopts the SIP in accordance with an embodiment of the invention. As shown in FIG. 4, CA 1 is a calling CA, CA 2 is a called CA, ER 1 is in the management domain managed by CM 1 and may import the traffic of this call to the bearer network, and CM 1 is the calling CM managed by CA 1, ER 2 is in the management domain managed by CM 3 and may export the traffic of this call from the bearer network, and CM3 is the called CM managed by CA 2. CM 2 is a midway CM by which this call request passes.

As shown in FIG. 4, the process includes the steps as follows.

Step 401: CA 1 receives a call request (invite) sent by UE 1.

Step 402˜403: CA 1 sends to CA 2 a call request carrying negotiation parameters of the communication capability of the calling side, such as the type of UE, decoding method of traffic and QoS parameters. After receiving the call request, CA 2 returns to CA 1 a 200 OK response carrying negotiation parameters of the communication capability of the called side. After receiving the 200 OK response, CA 1 acquires the communications capabilities of the calling side and the called side, that is, CA 1 acquires the resource requirements and QoS parameters including a delay parameter, a packet loss rate and a jitter.

Step 404: CA 1 sends a forward resource request carrying the negotiated resource requirements and QoS parameters to CM 1. After receiving the forward resource request, CM 1 sends the forward resource request downward hop by hop till the path calculation of this separate operating network is completed or till the home CM of UE 2, e.g., CM 3 in this embodiment, is reached. Each CM receiving the forward resource request selects a forward QoS policy meeting the resource requirements and the QoS parameters for the call, e.g., a forward intra-domain policy route and a forward inter-domain policy route, and reserves the forward path resources. The forward intra-domain policy route is a forward policy route in the management domain managed by the CM while the forward inter-domain policy route is a forward policy route between the management domain managed by the CM and the management domain managed by the CM of the next hop. Each of the CMs forwards the selected forward QoS policy to the CM 1 with a response message after selecting the forward QoS policy and reserving the forward path resources.

In Step 404, if a CM reserves the forward path resources successfully, the response message includes information of successfully reserving forward path resources; otherwise, the response message includes information of unsuccessfully reserving forward path resource.

In addition, the calculating method for each CM selecting the forward intra-domain policy route and the forward inter-domain policy route in Step 404 may be referred to in Chinese patents 03126471.9, 03160068.9 and 03156821.1, and will not be described herein.

Step 405: CM 1 determines whether the received response message includes the information of successfully reserving forward path resources; if yes, CM 1 issues the forward QoS policy and traffic state information to ER 1 and performs Step 406; otherwise, CM 1 returns a resource reserving failure response to CA 1 and Step 407 is performed.

In the invention, a QoS policy gated switch is set in the ER in the bearer network for managing the ER whether to forward traffic matching the forward QoS policy or the backward QoS policy. When the QoS policy gated switch is turned on, the ER forwards traffic matching the QoS policy; when the QoS policy gated switch is turned off, the ER does not forward traffic matching the QoS policy. The traffic state information carries instruction information for managing the QoS policy gated switch and a traffic identifier. The instruction information includes an instruction allowing forward traffic and an instruction forbidding forward traffic for turning on and turning off the QoS policy gated switch, respectively. The traffic identifier is 5-tuple information corresponding to the QoS policy and the 5tuple information corresponding to the QoS policy matches 5-tuple information of the traffic allowed or forbidden to be forwarded.

In Step 405, the traffic state information carries information for turning off the QoS policy gated switch, e.g., the instruction forbidding forward traffic, and the 5-tuple information corresponding to the QoS policy is the 5-tuple information of the forward QoS policy.

After receiving the forward QoS policy and the traffic state information, ER 1 reads the traffic state information and acquires the instruction forbidding forward traffic and the 5-tuple information of the forward QoS policy, and then turns off the QoS policy gated switch. Thus, even if receiving forward traffic matching the 5-tuple information of the forward QoS policy, ER 1 does not forward the forward traffic.

Alternatively, Step 405 may include the steps of: CM 1 does not issue the QoS policy but performs Step 406 directly.

Step 406: CM 1 returns a resource reserving success response to CA 1.

Step 407: CA 1 determines whether the received resource reserving response is a resource reserving success response; if yes, CA 1 sends to CA 2 a update (UPDATE) message indicating that CA 1 agrees with the negotiation parameters of communication capability of CA 2 and carrying a forward path resource reserving result, which is equivalent to a resource reserving success message and indicates that CA 1 successfully reserves resources for the current call; otherwise, CA 1 removes the QoS policy and releases the reserved forward path resources.

Step 408: After receiving the update message, CA 2 sends a backward resource request carrying the negotiated resource requirements and QoS parameters to CM 3. After receiving the backward resource request, CM 3 sends the backward resource request to the CM of the last hop till CM 1 is reached. Each CM receiving the backward resource request selects a backward QoS policy meeting the resource requirements and the QoS parameters for the current call and reserves the backward path resources. The backward QoS policy includes a backward intra-domain policy route and a backward inter-domain policy route. The backward intra-domain policy route is a backward policy route in the management domain managed by the CM, and the backward inter-domain policy route is a backward policy route between the management domain managed by the CM and the management domain managed by the CM of the last hop. Each of the CMs forwards the selected backward QoS policy to the CM 3 with a response message after selecting the backward QoS policy and reserving the backward path resources.

In Step 408, if the CM reserves the backward path resources successfully, the response message includes information of successfully reserving backward path resources; otherwise, the response message includes information of unsuccessfully reserving backward path resources.

In addition, the calculation method for each CM selecting the backward QoS policy in Step 408 may be referred to in Chinese patents 03126471.9, 03160068.9 and 03156821.1, and will not be described herein.

Step 409: CM 3 determines whether the received response message includes information of successfully reserving backward path resources; if yes, CM 3 issues the backward QoS policy and traffic state information to ER 2 and performs Step 410; otherwise, CM 3 returns a resource reserving failure response to CA 2 and Step 411 is performed.

Step 410: CM 3 returns a resource reserving success response to CA 2.

In Step 410, the traffic state information carries an instruction allowing forward traffic for turning on the QoS policy gated switch and the 5-tuple information matching the backward QoS policy. If ER 2 receives backward traffic matching the backward QoS policy, ER 2 forwards the backward traffic after receiving the traffic state information.

Step 411: CA 2 determines whether the received resource reserving response is a resource reserving success response; if yes, CA 2 sends to CA 1 a 200 OK message indicating that CA 2 agrees with the negotiating parameters of communication capability of CA 1 and a forward path resource reserving result in the update message and carrying a backward path resource reserving result, which is equivalent to a resource reserving success message, and sends a 200 OK response to UE 2; otherwise, CA 2 removes the QoS policy and releases the reserved backward path resources, and returns a resource reserving failure message to CA 1.

Step 412: CA 1 receives the response message of CA 2; if the response message is a 200 OK message, CA 1 instructs CM 1 to issue to ER 1 traffic state information carrying an instruction allowing forward traffic for turning on the QoS policy gated switch and the 5-tuple information matching the forward QoS policy, and CM 1 returns an execution response to CA 1 after issuing the traffic state information. After receiving the traffic state information, ER 1 forwards forward traffic matching the 5- tuple of the forward QoS policy based on the route of the forward QoS policy if ER 1 receives the forward traffic.

Alternatively, if CM 1 does not issue the forward QoS policy, CA 1 instructs CM 1 to issue the forward QoS policy and traffic state information carrying an instruction allowing forward traffic to ER 1. CM 1 returns an execution response to CA 1 after issuing the forward QoS policy and the traffic state information. After receiving the forward QoS policy and the allowing forward instruction. ER 1 forwards forward traffic matching the forward QoS policy based on the forward QoS policy if ER 1 receives the forward traffic.

CA 1 removes the QoS policy and releases the reserved forward path resources if CA 1 receives a resource reserving failure response.

Step 413: CA 1 sends a 200 OK message to UE 1 to notify UE 1 to start communicating after receiving the execution response of CM 1, and the traffic sent by UE 1 is forwarded to UE 2 through the bearer network.

In the embodiments of the invention, if the resource manager supports applying for bi-directional path resources only once, CA 1 sends a bi-directional resource request to CM 1 in Step 404. After receiving the bi-directional resource request, CM 1 sends the bi-directional resource request downward hop by hop till CM 3 is reached. Each CM receiving the bi-directional resource request selects a bi-directional QoS policy meeting the resource requirements and the QoS parameters for the current call and reserves bi-directional path resources. After selecting the bi-directional QoS policy and reserving the bi-directional path resources, each CM forwards the information of the selected forward QoS policy and the reserved forward path resources to CM 1 hop by hop with a response message, and forwards the information of the selected backward QoS policy and the reserved backward path resources to CM 3 hop by hop. CM 1 performs Steps 405 and 406, CM 3 performs Steps 40I and 410, and the operation of CA 1 and CA 2 is the same as that in the above process.

In the embodiment shown in FIG. 4, the multiple bearer network resource managers are in a single separate operating network. If a service connection crosses multiple separate operating networks and relates to multiple CAs, the level number of CAs in the embodiments of the invention increases correspondingly. However, the processing of the CAs, the CMs and the edge devices in the bearer network is the same as that in the embodiment shown in FIG 4.

In the embodiments of the invention, after a connection is established for a service call request, a CA may instruct the CM at any moment as demanded by the service to issue to the ER traffic state information for managing the QoS policy gated switch, and the traffic state information carries an instruction allowing forward traffic or an instruction forbidding forward traffic, and the 5- tuple information of the traffic allowed or forbidden to be forwarded. After receiving the traffic state information, if the traffic state information carries an instruction allowing forward traffic, the ER forwards the traffic based on the QoS policy matching the 5-tuple of the traffic after receiving traffic matching the 5-tuple information of the traffic allowed to be forwarded. If the traffic state information carries an instruction forbidden forward traffic, the ER does not forward the traffic after receiving traffic matching the 5-tuple information of the traffic forbidden to be forwarded. With the above method of the embodiments of the invention, in an end-to-end service connection, the bearer network may be managed to forward or stop forwarding traffic at any moment. Therefore, the embodiments of the invention provides a more flexible resource reserving method for the service layer, and are convenient for the development of an NGN value added service with demand for QoS. For example, the call hold service in the NGN allows UE to suspend the current call during the call, initiate a new call, and switch between the two calls after the new call is established. For the call hold service, when keeping the information of the original service connection, CA 1 and CM need to only issue an instruction of turning on or off the QoS policy gated switch of the original service connection to the ER in the bearer network so as to switch the call of the service connection between being turned on and being turned off and thus meet the demand of the call hold service. With the embodiments of the invention, the QoS policy of an original service connection may also be prevented from being usurped. For example, once the 5-tuple information of a service connection is blabbed, another UE may use the 5-tuple information to send traffic to a called, and when the traffic reaches an ER in the bearer network, the ER forwards the traffic based on the original QoS policy since the 5tuple information is the same as that of the original service connection. Thus, the QoS policy of the original service connection is usurped. In the embodiments of the invention, a QoS policy gated switch is provided for a QoS policy, and the QoS policy of the original service connection will not be usurped if the QoS policy gated switch is in the state of “off”.

When the service connection is disconnected for the moment, traffic state information for managing the QoS policy gated switch of the service connection is issued to the ER in the bearer network to set the QoS policy gated switch corresponding to the service connection as the state of “off”, and thus the bearer network does not forward the traffic of the service connection. When the service connection is put through, traffic state information for managing the QoS policy gated switch of the service connection is issued to the ER in the bearer network to set the QoS policy gated switch of the service connection as the state of “on”, and the bearer network continues to forward the traffic of the service connection using the original QoS policy instead of applying a new QoS policy, and thus the resource utilization efficiency of the bearer network may be improved. While the QoS policy of original service connection is kept, a new service connection may apply for resources based on the process of the embodiments of the invention.

The above process is a flow for establishing a bi-directional service connection. For the flow for establishing a unidirectional service connection, if multiple CAs reserve resources for the call of the service connection, the above method of the embodiments of the invention may also be applied only if the process of allocating the backward QoS policy and reserving the resources is omitted.

The foregoing is only preferred embodiments of the invention. The protection scope of the invention, however, is not limited to the above description. Any change or substitution, within the technical scope disclosed by the invention, easily occurring to those skilled in the art should be covered by the protection scope of the invention.

1. A method for forwarding traffic in a bearer network, comprising:
instructing, by a call agent (CA) related to a service call, a bearer network resource manager managed by the CA to allocate a Quality of Service (QoS) policy and reserve resources for the service call;
issuing, by the bearer network resource manager, the QoS policy to an edge device in a management domain managed by the bearer network resource manager,
forwarding, by the edge device, traffic matching the QoS policy after bearer network resource managers managed by CAs related to the service call successfully allocate QoS policies and reserve resources for the service call.

2. The method of claim 1, wherein the issuing the QoS policy to an edge device in a management domain managed by the bearer network resource manager comprises:
issuing the QoS policy to the edge device in the management domain managed by the bearer network resource manager after the CA determines that a bearer network resource manager managed by any other CA related to the service call successfully allocates a QoS policy and reserves resources for the service call.

3. The method of claim 2, wherein the determining that a bearer network resource manager managed by any other CA related to the service call successfully allocates a QoS policy and reserve resources comprises:
sending, by the bearer network resource manager managed by any other CA related to the service call, a resource reserving success message after successfully allocating the QoS policy and reserving the resources;
determining, by the CA, that the bearer network resource manager managed by any other CA related to the service call successfully allocates the QoS policy and reserves the resources after receiving the resource reserving success messages.

4. The method of claim 1, wherein the issuing the QoS policy to an edge device in a management domain managed by the bearer network resource manager comprises:
issuing, by the bearer network resource manager, the QoS policy and an instruction forbidding forwarding the traffic matching the QoS policy to the edge device;
the forwarding traffic matching the QoS policy comprises:
issuing an instruction allowing forwarding the traffic matching the QoS policy to the edge device after the CA determines that a bearer network resource manager managed by any other CA related to the service call successfully allocates a QoS policy and reserve resources for the service call;
forwarding, by the edge device, the traffic matching the QoS policy after receiving the instruction allowing forwarding the traffic matching the QoS policy.

5. The method of claim 4, wherein the determining that a bearer network resource manager managed by any other CA related to the service call successfully allocates a QoS policy and reserves resources comprises:
sending, by the bearer network resource manager managed by any other CA related to the service call, a resource reserving success message after successfully allocating the QoS policy and reserving the resources;
determining, by the CA, that the bearer network resource manager managed by any other CA related to the service call successfully allocates the QoS policy and reserves the resources after receiving the resource reserving success messages.

6. The method of claim 1, further comprising:
issuing, by the bearer network resource manager, to the edge device an instruction forbidding forwarding the traffic matching the QoS policy during forwarding by the edge device traffic matching the QoS policy;
stopping, by the edge device, forwarding the traffic matching the QoS policy after receiving the instruction forbidding forwarding the traffic matching the QoS policy; and
continuing, by the edge device, forwarding the traffic matching the QoS policy after receiving an instruction allowing forward the traffic matching the QoS policy from the bearer network resource manager.

7. The method of claim 4, wherein the instruction forbidding forwarding the traffic matching the QoS policy and the instruction allowing forwarding the traffic matching the QoS policy are issued to the edge device through traffic state information.

8. The method of claim 6, wherein the stopping forwarding the traffic matching the QoS policy comprises:
turning off, by the edge device, a gated switch for managing the edge device to forward the traffic matching the QoS policy when receiving traffic state information containing an instruction forbidding forwarding the traffic matching the QoS policy to stop forwarding the traffic matching the QoS policy;
the continuing forwarding the traffic matching the QoS policy comprises:
turning on, by the edge device, the gated switch when receiving traffic state information containing an instruction allowing forwarding the traffic matching the QoS policy to continue forwarding the traffic matching the QoS policy.

9. The method of claim 1, wherein the QoS policy is matched with the traffic through 5-tuple information.

10. The method of claim 1, wherein the edge device is an Edge Router (ER).

11. The method of claim 1, wherein there is at least one CA related to the service call.

12. A system for forwarding traffic in a bearer network, comprising:
a Call Agent (CA) related to a service call, a bearer network resource manager managed by the CA and an edge device in a management domain managed by the bearer network resource manager; wherein
the CA is configured to instruct the bearer network resource manager to allocate a Quality of Service (QoS) policy and reserve resources for the service call;
the bearer network resource manager is configured to issue the QoS policy after allocating the QoS policy and reserving the resource for the service call;
the edge device is configured to forward traffic matching the QoS policy after bearer network resource managers managed by CAs related to the service call successfully allocate QoS policies and reserve resources for the service call.

13. The system of claim 12, wherein the bearer network resource manager managed by the CA issues the QoS policy to the edge device after the CA determines that a bearer network resource manager managed by any other CA related to the service call successfully allocates a QoS policy and reserves resources for the service call.

14. The system of claim 13, wherein the bearer network resource manager managed by any other CA related to the service call sends a resource reserving success message after successfully allocating the QoS policy and reserving the resources;
the CA determines that the bearer network resource manager managed by any other CA related to the service call successfully allocates the QoS policy and reserves the resources after receiving the resource reserving success message sent by any other CA.

15. The system of claim 12, wherein the bearer network resource manager issues an instruction forbidden forwarding the traffic matching the QoS policy to the edge device when issuing the QoS policy, and issuing an instruction allowing forwarding the traffic matching the QoS policy to the edge device after the CA determines that a bearer network resource manager managed by any other CA related to the service call successfully allocates a QoS policy and reserve resources for the service call;
the edge device forwards the traffic matching the QoS policy after receiving the instruction allowing forwarding the traffic matching the QoS policy.

16. The system of claim 15, wherein the bearer network resource manager managed by any other CA related to the service call sends a resource reserving success message after successfully allocating the QoS policy and reserving the resources;
the CA determines that the bearer network resource manager managed by any other CA related to the service call successfully allocates the QoS policy and reserves the resources after receiving the resource reserving success message sent by any other CA.

17. The system of claim 12, further comprising:
a gated switch, configured to manage the edge device whether to forward the traffic matching the QoS policy; wherein
the edge device turns off the gated switch when receiving traffic state information containing an instruction forbidding forwarding the traffic matching the QoS policy to stop forwarding the traffic matching the QoS policy;
the edge device turns on the gated switch when receiving traffic state information containing an instruction allowing forwarding the traffic matching the QoS policy to continue forwarding the traffic matching the QoS policy.
